(19) United States
(12) Patent Application Publication
(10) Pub. No.: US 2016/0034179 A1
(43) Pub. Date: Feb. 4, 2016

(54) DUAL DIRECTIONAL CONTROL FOR TEXT ENTRY

(71) Applicant: Microsoft Corporation, Redmond, WA (US)

(72) Inventor: Fernando Reyes Medina, Redmond, WA (US)

(21) Appl. No.: 14/448,328

(22) Filed: Jul. 31, 2014

(51) Int. Cl. G06F 3/0488; G06F 3/0484; G06F 3/0482

(52) U.S. Cl. CPC G06F 3/04886; G06F 3/0482; G06F 3/04842

(57) ABSTRACT

Disclosed herein are systems and methods for text using directional input. A computing system causes display of a user interface including a first set of characters and a second set of characters. A first directional control of a user input device is associated with the first set of characters, and a second directional control of the user input device is associated with the second set of characters. Characters are selected based on receipt of directional input from the directional controls, and based on detecting that directional input ceases, the selected characters are input into a text entry portion of memory.

### BACKGROUND

In conventional text input using a two-handed game controller, a virtual or soft keyboard is displayed within a user interface. The user manipulates thumbsticks or directional pads to select a desired letter and then presses some other key to input or “enter” the desired letter. Thus, each letter entry requires two user actions: one for character selection, the other for user input. Also, such virtual keyboards suffer from variable distances between characters. For example, in a typical QWERTY-type soft keyboard layout, the letter “Q” is much closer to “W” than to “U.” Thus, there is a variable amount of time for selection of the characters as the user enters text. This is in contrast to typing on a physical keyboard, in which each key of the keyboard can be selected in about the same amount of time as any other key. For these reasons, typing on soft keyboards is often slow and tedious.

### BRIEF SUMMARY

This Summary is provided in order to introduce simplified concepts of the present disclosure, which are further described below in the Detailed Description. This summary is not intended to identify essential features of the claimed subject matter, nor is it intended for use in determining the scope of the claimed subject matter.

Embodiments of the present disclosure include user interfaces with two sets of characters arranged around two central points (e.g., arranged in pie menus). Directional user input using the left thumbstick or control pad of a user input device (such as a game controller) selects characters of a first set of characters displayed on the left, and directional user input using the right thumbstick or control pad selects characters in the second set of characters displayed on the right. Release of one of the thumbsticks or control pads causes the selected character associated with that thumbstick or pad to be input.

Embodiments include various arrangements of characters, such as alphabetic arrangements, QWERTY-style arrangements, arrangements that separate characters in commonly typed bigrams, arrangements that are designed to make it easier to select more commonly selected characters, and so forth. Embodiments speed up text entry using soft keyboards, making text entry less tedious and frustrating.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which directional controls of a user input device is used to enter text via a user interface.

FIG. 2 illustrates an example user interface displayed on display device and having an arrangement of characters that mimics a QWERTY-style keyboard.

FIG. 3 illustrates an example user interface displayed on display device and having an arrangement of characters that separate characters of commonly typed bigrams of a predetermined language.

FIG. 4 illustrates an example user interface displayed on a display device and having an arrangement of characters where commonly typed characters are placed to enable more comfortable selection by a user.

FIG. 5 illustrates an example user interface displayed on a display device and having numeral and punctuation characters.

FIG. 6 depicts a flow diagram of an example process for enabling dual directional control for text entry.

FIG. 7 is a block diagram of an example computing system usable to perform various methods described herein.

### DETAILED DESCRIPTION

### Overview

Embodiments of the present disclosure include a user interface with two sets of characters arranged around two central points. Directional user input using the left thumbstick or control pad of a user input device (such as a game controller) selects one of the first set of characters, and directional user input using the right thumbstick or control pad selects one of the second set of characters (which may be displayed to the right of the first set of characters). Release of one of the thumbsticks or control pads causes the selected character associated with that thumbstick or pad to be input. Thus, similar to typing on a traditional keyboard, the user is able to use both hands to enter text, thereby greatly speeding up text entry and improving user efficiency (such as by increasing words-per-minute) using directional controls on a two-handed user input device. In addition, there is little or no variation in the amount of time it takes to select different characters. And from the point of view of the user, a single “action” selects a character, potentially making it seem similar to typing on a keyboard, where pressing a single key enters text.

The devices, processes, and systems described herein may be implemented in a number of ways. Example implementations are provided below with reference to the following figures.

### Example Environment

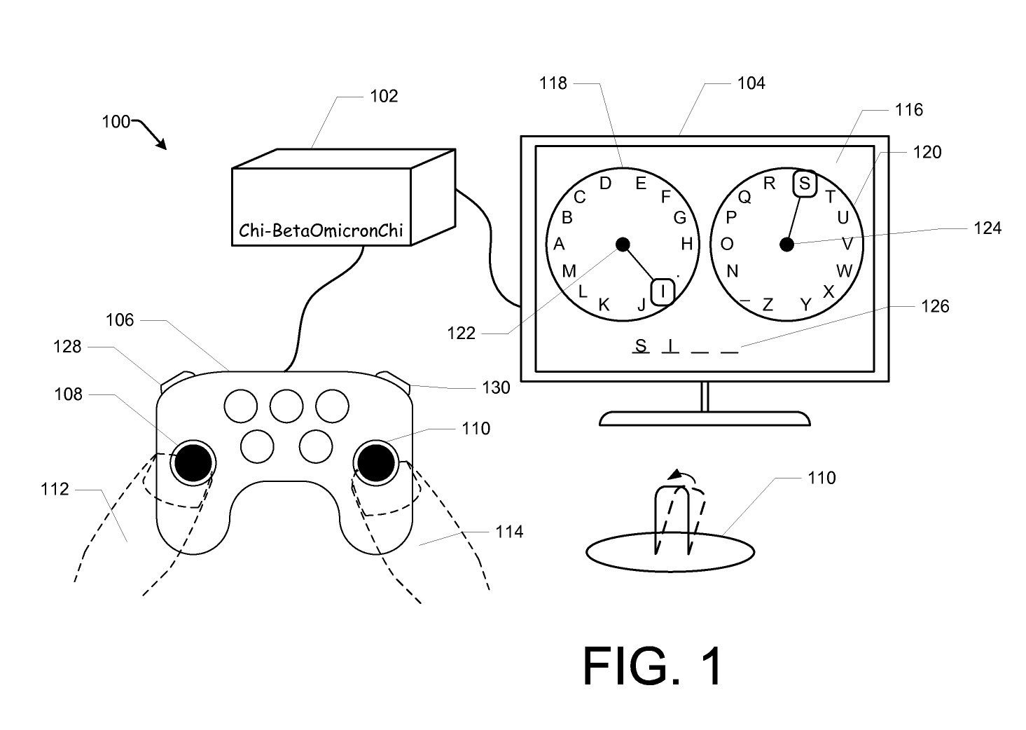

FIG. 1 illustrates an example environment 100 in which directional controls of a user input device are used to enter text via a user interface. A computing system 102 is coupled to a display device 104. The computing system 102 includes, or is coupled to, a user input device 106. The user input device 106 includes two directional controls 108 and 110. As illustrated in FIG. 1, the directional controls 108 and 110 are situated on the user input device 106 and are configured to be operable by a user's thumbs 112 and 114. The directional controls 108 and 110 may be control sticks, such as thumbsticks, joysticks, or other. In the same or different embodiments, one or more of the directional controls 108 and 110 may be a control pad, or other type of directional control operated by a user. The directional controls 108 and 110 are centering controls that automatically return to their central position when the user releases them, or stops applying force to them.

The computing system 102 is configured to cause display of a user interface 116 on the display device 104. The user interface 116 includes a first set of characters 118 and a second set of characters 120. The first set of characters 118 are arranged around a first point 122, with no more than one of the first set of characters is situated along any one radial line from the first point 122. Similarly, the second set of characters 120 are arranged around a second point 124 such that no more than one of the second set of characters 120 is situated along any one radial line extending from the second point 124.

The computing system 102 associates directional input from a first one of the directional controls 108 and 110 (e.g., the left-hand directional control 108) with the first set of characters 118. The computing system 102 associates directional input from a second one of the directional controls 108 and 110 (e.g., the right-hand directional control 110) with the second set of characters 120. Directional input from the first directional control 108 (or 110) is matched to ones of the first set of characters 118, such that the direction of the received directional input corresponds with a selected one of the first set of characters. The selected one of the first set of characters is situated at a radial direction from the first point 122 that corresponds to the directional input received from the first directional control 108. Thus, in the example illustrated in FIG. 1, a user presses the first directional control 108 downward and the right, thereby corresponding with the letter “I” in the first set of characters 118.

Similarly, directional input from the second directional control 110 (or 108) is matched to ones of the second set of characters 120, such that the direction of the received directional input corresponds with a selected one of the second set of characters 120. The selected one of the second set of characters 120 is situated at a radial direction from the second point 124 that corresponds to the directional input received from the second one of the directional controls 108 or 110. Thus, in the example illustrated in FIG. 1, a user presses the second directional control 110 upward and slightly to the right, thereby corresponding with the letter “S” in the second set of characters 120. The selected ones of the first and second sets of characters 118 and 120 may be highlighted in some way, such as by one or more of making the character larger, flashing the selected character, making the character a different color, drawing a border around the selected character (as in FIG. 1), or in some other way to indicate visually which of the characters is being selected.

The computing system 102 detects that the directional input from the directional controls 108 and/or 110 cease. Upon detecting cessation of the directional input, the computing system 102 inputs the selected ones of the first and/or second set of characters 118 and 120 into a text entry portion of memory within the computing system 102. The directional controls 108 and 110 may include a spring or other mechanism that causes them to return to a central location once the user releases them (see side view of directional control 110 in FIG. 1). Thus, the user manipulates the directional controls 108 and 110 (such as using his or her thumbs 112 and 114), and once the desired character is selected, the user releases the directional control 108 or 110, thereby causing the directional control to re-center, in order to cause the selected character to be input.

Thus, in the example illustrated in FIG. 1, the user presses the directional control 108 downward and to the right to select the character “I”, and then releases the directional control; the user input device 106 communicates to the computing system 102 that the directional input has ceased (or has otherwise returned to a neutral condition). The computing system 102 interprets this cessation of user input as a command to input the selected character into a text entry portion of memory. The computing system 102 may also cause the inputted character(s) to be displayed within a text entry portion 126 of the user interface 116. The computing system 102 accepts the next directional input from the user input device 106, and upon cessation of that directional input, causes another character to be input into the text entry portion of memory and causes display of that character within the user interface 116. In this way, the user is able to type a string of characters using both hands, in a way that is somewhat similar to two-handed typing on a conventional keyboard.

The computing system 102 may be, in various embodiments, a personal computer system, such as a desktop computer, a laptop computer, and the like. The computing system 102 may be, in various embodiments, a mobile device or a handheld device, such as a mobile telephone (e.g., a smartphone), a tablet computer, a personal data assistant, a portable media player, and the like. The computing system 102 may be a console device, such as a game console, an internet television appliance, a media player, and so forth. The computing system 102 may be a wearable device, such as a smart watch, smart glasses, computerized clothing, and so forth.

The display device 104 may be, in various embodiments, a television, a computer monitor, or other device. The display device may be a touch-sensitive display. The user input device 106 may be a two-handed device, such as a game controller. The user input device 106 may be a remote control for a television, or other type of user input device.

Although the computing system 102 is illustrated in FIG. 1 as being wired to the display device 104 and to the user input device 106, various wireless communication links may be used to couple one or both of those devices to the computing system 102. In addition, the display device 104 may be integrated within the computing system 102, such as in the case of a handheld device or other type of device with an integrated display.

The first set of characters 118 and the second set of characters 120 are upper-case roman letters, but other types of characters, including punctuation characters, lower-case characters, or characters from other alphabets and/or languages are possible without departing from the scope of embodiments. Other controls on the user input device 106, such as buttons 128 and 130, may be usable as “shift” buttons to toggle between upper and lower-case characters, to toggle between different sets of characters, or other functions. The user interface 116 may also include soft menus or other controls that are selectable to switch between different characters, such as between letters, numbers, punctuation (or other “special” characters), different alphabets, and so forth.

In the example illustrated in FIG. 1, the period and space characters are ones of the sets of characters available for selection based on the directional controls 108 and 110. In the same or different embodiments, such commonly typed special characters (e.g., punctuation characters or other), may be selectable by other buttons, such as the buttons 128 or 130. In one non-limiting example, the button 128 may cause input of a space, while the button 130 may cause entry of a period. The same or different buttons may be used for other common characters, such as commas, quotations, semicolons, and so forth.

### Analysis of Typing Speed and Accuracy

Fitts' Law is an empirical model that explains the speed-accuracy tradeoff of human muscle movement. According to Fitts' Law, the movement time (MT) to point to a target is determined by the width (W) of the target and the distance (A) to the target from an initial starting point of a pointer. Fitts' Law can be formulated as in the following equation:

$$MT = a + b {log}_{2} ( \frac{A}{W} + 1 )$$

In this formulation, a and b are empirical constants that can be found using a regression analysis on the movement time; a is the intercept of the regression line and b is the slope. The term log₂

$$( \frac{A}{W} + 1 )$$

is called the “index of difficulty” (ID) and it describes the difficulty of the motor task. 1/b is called the “index of performance” (IP).

From Fitts' Law it follows that: big targets at close distance are acquired faster than small targets at long range; ID provides a single combined measure of these two main physical properties of movement tasks (A and W); and ID increases by one unit for each doubling of amplitude or halving of width.

In user interfaces according to the present disclosure, the sets of characters (such as the sets of characters 118 and 120) are pie menus. Pie menus are fast menu types because the movement amplitudes (A in the equation above) are relatively short and the target widths (Win the equation above) are relatively large.

In the example shown in FIG. 1, there are fourteen characters in both the first set of characters 118 and the second set of characters 120. More or fewer characters could be placed into each set without departing from the scope of embodiments, including different numbers of characters in the two sets of characters (e.g., 13 characters in one set, 15 characters in the other). At a certain point, however, such as for example around 20 characters or more in one set, it becomes increasingly difficult for a user to accurately select the character he or she is aiming for using directional controls 108 and 110. The more characters there are in a set, the smaller is W in the equation above, thereby making the movement task relatively more difficult (the ID increases). Looked at another way, the more characters there are in a set, the more manual dexterity is required to select a target character. With an arrangement of fourteen characters per set (as shown in FIG. 1), accuracy is generally not a problem for the average user.

Also, the pie menus of the present application have uniform (and relatively short) amplitudes A for each character in each set of characters, thereby making typing speed relatively fast (compared to other soft keyboard types) and each character can be selected as quickly as any other, thereby reducing the variability of typing speed, which improves the user perception of ease of use. And because embodiments input a selected character upon identifying the cessation of directional input, the user is not required to press a confirming button to cause the selected character to be input, which is a common feature of many soft keyboards. This also improves typing performance, and makes the experience more akin to traditional typing on a manual keyboard than conventional soft keyboards.

The examples illustrated herein include dual pie menus, or similar, with one directional control controlling one pie menu and the other directional control controlling another pie menu. However, embodiments are not limited to only two pie menus. Embodiments include, for example, a single pie menu with one directional control controlling the single pie menu. A toggle control may switch control from a left to right directional control, or vice versa. In some embodiments, three or more pie menus may be displayed at the same time, with toggle switches choosing which pie menus are controlled by which directional controls.

### Arrangements of Characters

The first set of characters 118 and the second set of characters 120 are grouped in an alphabetic manner; e.g., the first set of characters 118 have those characters coming early in the alphabet and the second set of characters 120 includes those characters that come later in the alphabet. Other arrangements of characters are possible; examples illustrated in the figures that follow include a few of such examples. Other examples are possible without departing from the scope of embodiments.

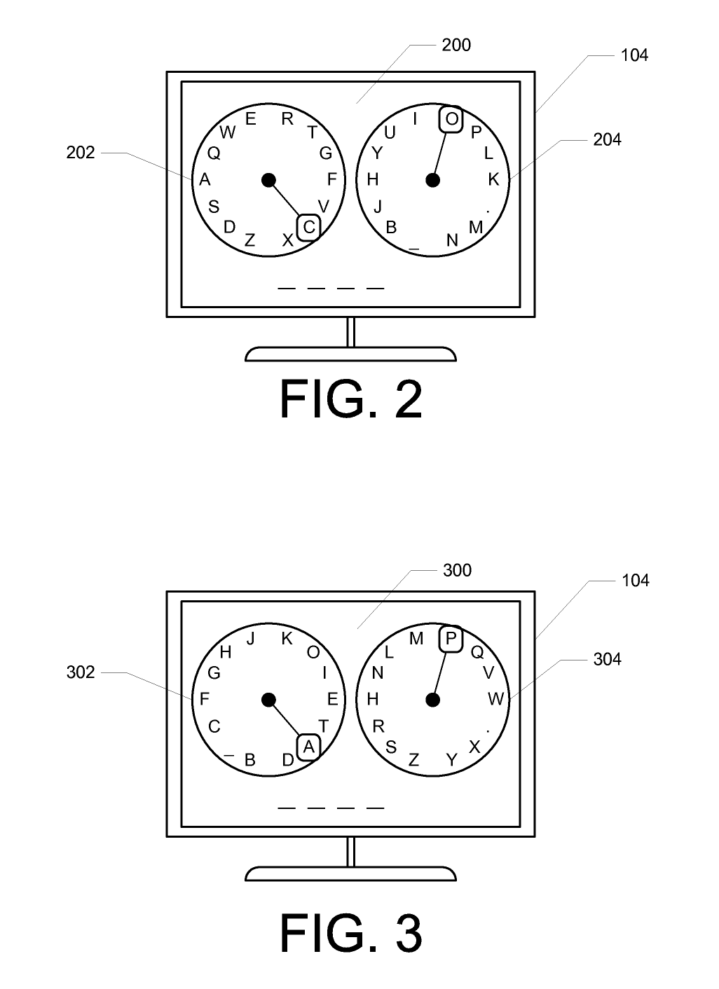

FIG. 2 illustrates an example user interface 200 displayed on display device 104 and having an arrangement of characters that mimics a QWERTY-style keyboard. The sets of characters 202 and 204 are arranged such that the first set of characters 202, displayed on the left of the second set of characters 204, includes those characters that are found on the left-hand side of a conventional QWERTY-style keyboard. The set of characters 204, displayed to the right of the first set of characters 202, includes those characters that are found on the right-hand side of a conventional QWERTY-style keyboard. Thus, a user with experience typing on a QWERTY-style keyboard may find typing characters using the arrangement of characters shown in FIG. 2 more efficient than typing with other character arrangements.

FIG. 3 illustrates an example user interface 300 displayed on display device 104 and having an arrangement of characters that separate characters of commonly typed bigrams of a predetermined language. In the English language, for example, commonly typed bigrams (two-letter pairs where each character of a bigram is typed one after another) may include the following bigrams (in descending order of frequency):
TH, HE, IN, ER, AN, RE, ON, AT, EN, ND, TI, ES . . .

These letter pairs are the most common letter pairs in English. For example the word “the” includes common bigrams TH and HE. The word “there” includes common bigrams TH, HE, ER and RE. The first set of characters 302 and the second set of characters 304 separate the characters of all but one of above listed bigrams (AT). For example, the bigram TH has character T in the first set of characters 302 and character H in the second set of characters 304. The bigram HE has a character H in the second set of characters 304 and character E in the first set of characters. In the list of common English bigrams listed above, only AT includes characters in the same set of characters in FIG. 3 (the first set of characters 302 includes both A and T). It may be possible to find an alternative arrangement such that more common bigrams are separated.

Separating the characters of commonly typed bigrams makes typing using directional controls faster and more efficient. For example, it may be faster for a user to select a letter with his or her right thumb and then select the next character with his or her left thumb (or vice versa), than to sequentially input two characters using the same thumb. Arranging characters in the user interface 300 such that commonly typed bigrams are separated, and thus can be typed using both hands rather than one, may make typing faster for some users than other arrangements.

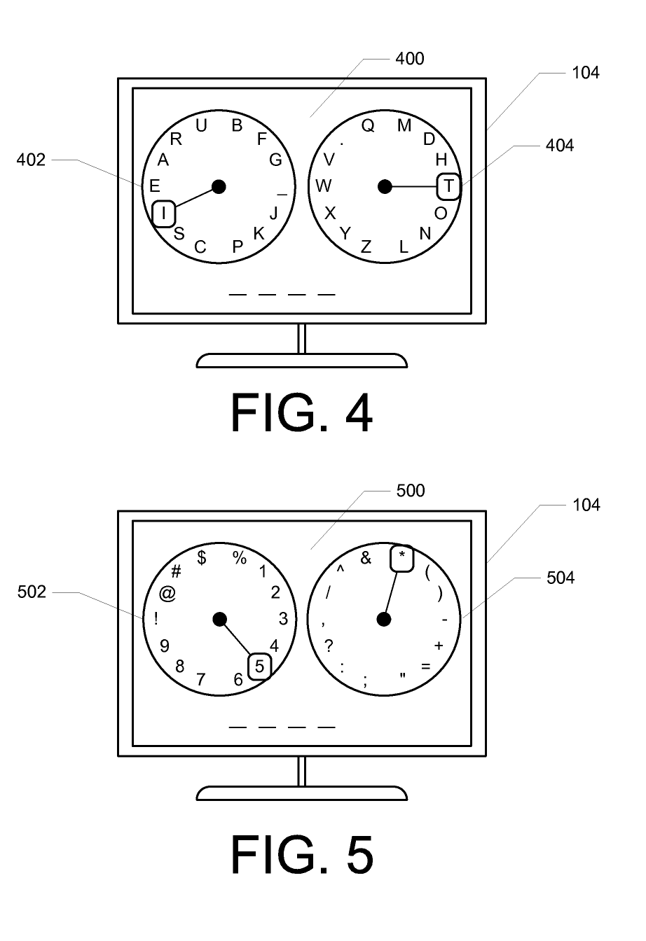

FIG. 4 illustrates an example user interface 400 displayed on a display device 104 and having an arrangement of characters where commonly typed characters are placed to enable more comfortable and efficient selection by a user. As discussed above, in embodiments, the user input device 106 is a game controller having two thumbsticks. Directional input received from the thumbsticks selects characters situated around a central point and release of the thumbsticks, determined for example based on cessation of the directional control, causes a computing system (such as the computing system 102) to input the selected character. Some users may find it easier or more comfortable to bring their thumbs towards their palms rather than push their thumbs away from their palms. Thus, a user may find it more comfortable to type letters on the left side of the first set of characters 402 and likewise a user may find it more comfortable to type the letters on the right side of the second set of characters 404.

In English language, the most commonly typed letters may be (in descending order of frequency):
E, T, A, O, I, N, S, H, R, D, L, C, U, M, W . . .

Thus, the arrangement of characters in the user interface 400 are such that more frequently selected ones of the first set of characters 402 are situated in first radial directions relative to a central point, and less frequently selected ones of the first set of characters 402 are situated in second radial directions relative to the central point, wherein manipulation of the first directional control of the game controller associated with the first radial directions includes a thumb pulling motion towards the user's palm, and manipulation of the first thumbstick associated with the second radial directions includes a thumb pushing motion away from the user's palms.

Likewise, the more frequently selected ones of the second set of characters 404 are situated in first radial directions relative to a central point, and less frequently selected ones of the second set of characters 404 are situated in second radial directions relative to the central point, wherein manipulation of the second directional control of the game controller associated with the first radial directions includes a thumb pulling motion towards the user's palm, and manipulation of the first thumbstick associated with the second radial directions includes a thumb pushing motion away from the user's palms. Thus, a user may find typing using the user interface 400 less tiring than other arrangements of characters where more commonly typed characters are situated such that the user uses a pushing motion to select such characters.

FIG. 5 illustrates an example user interface 500 displayed on a display device 104 and having numeral and punctuation characters in first set of characters 502 and punctuation characters in the second set of characters 504. Other characters could be displayed without departing from the scope of embodiments. For example, options for an equation editor are displayed in the same or different embodiments (such as square root symbol, Greek letters, and so forth). As noted above, characters from other alphabets are displayed in the same or other embodiments.

In some embodiments, such as embodiments that enable typing of alphabets that have a large number of characters, such as Chinese Hanzi and Japanese Kanji, selections of multiple characters cause third characters to be input into the text entry portion of memory. These third characters could be combinations or hybrids of two simultaneously or contiguously typed characters, such as two characters from the first and second sets of characters. Determining a “simultaneously” typed character may be based on determining that two characters are input within a certain predetermined threshold period of time of one another; in these embodiments, such characters may be selected and then input simultaneously, such as by concurrent selection using the two directional controls and synchronized release of the directional controls. Furthermore, selection of one character could cause the choice of characters displayed on the user interface to change, enabling the user to select additional characters to be used for creating hybrid or combination characters.

### Example Processes

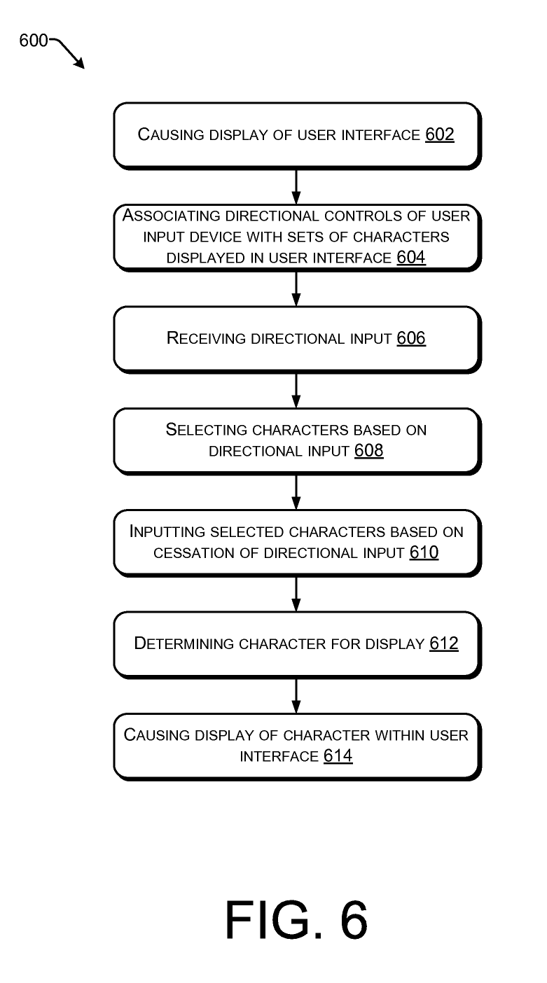

FIG. 6 depicts a flow diagram of an example process 600 for enabling dual directional control for text entry. At 602, a computing system, such as the computing system 102, causes display of a user interface including a first set of characters and a second set of characters. The first set of characters are located along first radial vectors that extend outward from a first point, and the second set of characters are located along second radial vectors that extend outward from a second point, such that no more than one of the first set of characters and no more than one of the second set of characters are located along any one of the first radial vectors and second radial vectors, respectively.

At 604, the computing system associates at least a first directional control of a user input device with the first set of characters and a second directional control of the user input device with the second set of characters. The first directional control and may be a left-handed directional control of a game controller, and the first set of characters may be displayed within the user interface to the left of the second set of characters. Likewise, the second directional control may be a right-handed directional control of the game controller and the second set of characters may be displayed to the right of the first set of characters. Other types of user input devices are used in various embodiments.

At 606, the computing system receives directional input from the user input device. The signals provided by the user input device to the computing system provide information about the directions that the directional controls are pressed by a user. Analog or digital signals from the user input device provide the computing system with directional information.

At 608, the computing system selects one or more of: a first character of the first set of characters based on receipt of the directional input from the first directional control, and a second character of the second set of characters based on receipt of the directional input from the second directional control. A selected character is located in the radial direction, relative to a central point of a set of characters, which corresponds to the directional input. The selection of a character may occur after the selection of an initial character based on an initial direction of the directional control, and the selection of another character may be based on a change of the first directional input from the initial direction to a direction that corresponds to a subsequently selected character without detecting an cessation of the directional input. Thus, the user is able to adjust the selection of the characters before causing one of the characters to be input.

At 610, the computing system, based on detecting that one or more of the first directional input or the second directional input ceases, inputs the selected character(s) into a text entry portion of memory of the computing system. The character that is selected just prior to detecting cessation of directional control is input; thus where an initial character is selected and the directional input changes to select another character, the initial character is not input. Also, the directional controls of the user input device may be centering controls; a centering control will return to its original or central location when the user stops applying force to it, such as by action of a spring or other mechanism. As used herein, cessation or ceasing of directional input does not necessarily mean that no signals are received from the directional control or that such signals stop being received; instead cessation of directional input indicates that the directional control has been returned to its neutral or central location, either by user action or by a centering feature of the directional control. The computing system may receive a signal indicating a neutral or central placement of the directional control (e.g., a no direction signal) when this occurs, rather than simply receiving no signal at all. Embodiments are not limited in this regard.

At 612, the computing system determines a character for display in a text entry field within the user interface. The character determined for display may be, in some embodiments, the character input into the text entry portion of memory. In other embodiments, the characters determined for display may be determined based on simultaneous or contiguous selections of other characters. Such characters may be hybrid or combination characters. For example, such input methods may be used to enter Chinese characters, Japanese characters, or characters from other languages and alphabets.

At 614, the computing system causes display of a character in the text entry field within the user interface.

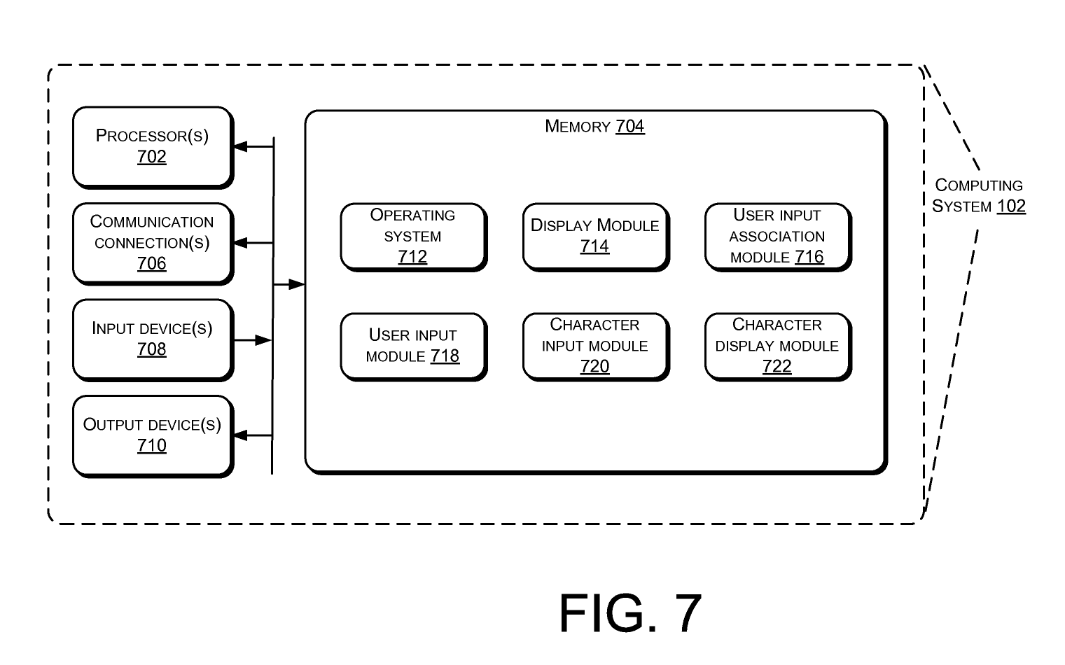

FIG. 7 is a block diagram of an example computing system 102 usable to perform various methods described herein. In one example configuration, the computing system 102 comprises one or more processors 702 and memory 704. The computing system 102 may also contain communication connection(s) 706 that allow communications with various other systems. The computing system 102 may also include one or more input devices 708, such as the user input device 106, as well as a keyboard, mouse, pen, voice input device, touch input device, etc., and one or more output devices 710, such as a display, speakers, printer, etc. coupled communicatively to the processor(s) 702 and the memory 704.

The memory 704 may store program instructions that are loadable and executable on the processor(s) 702, as well as data generated during execution of, and/or usable in conjunction with, these programs. In the illustrated example, memory 704 stores an operating system 712, which provides basic system functionality of the computing system 102 and, among other things, provides for operation of the other programs and program modules of the computing system 102.

A display module 714 is executable to cause display of a user interface, the user interface including a first set of characters and a second set of characters. The display module 714 is configurable to display different sets of characters, as well as different arrangements of characters, as described herein. For example, the display module may cause display of Roman characters in an alphabetic fashion (see e.g., the arrangement illustrated in FIG. 1), in a QWERTY arrangement (see e.g., the arrangement illustrated in FIG. 2), so as to separate characters of commonly typed bigrams (see e.g., the arrangement illustrated in FIG. 3), so as to place commonly typed characters in a more comfortable or ergonomic position (see e.g., the arrangement illustrated in FIG. 4), to provide options for typing numerical characters as well as punctuation or other special characters (see e.g., the arrangement illustrated in FIG. 5). Display of other arrangements and/or types of characters are possible without departing from the scope of embodiments.

A user input association module 716 is executable to associate directional controls, as well as associated directional input, of a user input device with sets of characters displayed within a user interface. A first directional control and may be a left-handed directional control of a game controller, and a first set of characters may be displayed within the user interface to the left of a second set of characters. Likewise, a second directional control may be a right-handed directional control of the game controller and the second set of characters may be displayed to the right of the first set of characters. Other types of user input devices are used in various embodiments.

A user input module 718 selects characters based on radial directions of directional input received from the user input devices. The selection of a character occurs after the selection of an initial character based on an initial direction of the directional control, and the selection of another character may be based on a change of the first directional input from the initial direction to a direction that corresponds to a subsequently selected character without detecting an cessation of the directional input. Thus, the user is able to adjust the selection of the characters before causing one of the characters to be input. The user input module 718 receives data corresponding to the directional input received from the user input device.

A character input module 720 is executable to input into a text entry portion of the memory one of the characters based at least on cessation of the directional input associated with the directional controls. The character that is selected just prior to detecting cessation of directional control is input by the character input module 720; thus where an initial character is selected and the directional input changes to select another character, the initial character is not input. As used herein, cessation or ceasing of directional input does not necessarily mean that no signals are received from the directional control or that such signals stop being received; instead cessation of directional input indicates that the directional control has been returned to its neutral or central location, either by user action or by a centering feature of the directional control.

A character display module 722 is executable to determine and cause display of the inputted characters within the user interface. The character determined for display may be, in some embodiments, the character input into the text entry portion of memory. In other embodiments, the characters determined for display may be determined based on simultaneous or contiguous selections of other characters. Such characters may be hybrid or combination characters. For example, such input methods may be used to enter Chinese characters, Japanese characters, or characters from other languages and alphabets. Determining a hybrid character from two concurrently entered characters may be based on the characters being input into the text entry portion of memory within a predetermined amount of time of one another.

Embodiments include means for causing display of a user interface including a first set of characters and a second set of characters. Such means include a display module, such as the display module 714.

Embodiments include means for associating directional control(s) of a user input device with sets of characters displayed within the user interface. Such means include a user input association module, such as the user input association module 716.

Embodiments include means for selecting character(s) based on receipt of directional input from the directional controls. Such means include a user input module, such as the user input module 718.

Embodiments include means for inputting selected characters into a text entry portion of memory based on detecting that one of the directional input ceases the first character or the second character. Such means include a character input module, such as the character input module 720.

Embodiments include means for causing characters to be displayed in a text entry field within the user interface based on the characters input into the text entry portion of memory. Such means include a character display module, such as the character display module 722.

### Computer-Readable Media

Depending on the configuration and type of computing device used, memory 704 of the computing system 102 in FIG. 7 may include volatile memory (such as random access memory (RAM)) and/or non-volatile memory (such as read-only memory (ROM), flash memory, etc.). Memory 704 may also include additional removable storage and/or non-removable storage including, but not limited to, SSD (e.g., flash memory), HDD storage or other type of magnetic storage, optical storage, and/or tape storage that may provide non-volatile storage of computer-readable instructions, data structures, program modules, and other data for computing system 102.

Memory 704 is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission, non-communication medium that can be used to store information for access and retrieval by a computing device. In contrast, communication media may embody computer-readable instructions, data structures, program modules, or other data in a modulated data signal, such as a carrier wave, or other transmission mechanism. As defined herein, computer storage media does not include communication media.

### Example Clauses

A. A method comprising: causing display of a user interface including a first set of characters and a second set of characters; associating a first directional control of a user input device with the first set of characters; associating a second directional control of the user input device with the second set of characters; selecting at least one of: a first character of the first set of characters based on receipt of first directional input from the first directional control, and a second character of the second set of characters based on receipt of second directional input from the second directional control; and based on detecting that one of the first directional input or the second directional input ceases, inputting the first character or the second character, respectively, into a text entry portion of memory.

B. The method as in paragraph A, wherein: the first set of characters are located along first radial vectors that extend outward from a first point, and the second set of characters are located along second radial vectors that extend outward from a second point, such that no more than one of the first set of characters and no more than one of the second set of characters are located along any one of the first radial vectors and second radial vectors, respectively, and the first character is located in a first radial direction, relative to the first point, that corresponds to the first directional input, and the second character is located in a second radial direction, relative to the second point, that corresponds to the second directional input.

C. The method as in paragraph A, further comprising causing at least one of the first character or the second character to be displayed in a text entry field within the user interface.

D. The method as in paragraph A, further comprising based on inputting both the first character and the second character, determining a third character for text entry.

E. The method as in paragraph D, wherein the first set of characters correspond to characters for left-hand typing on a QWERTY keyboard layout, and the second set of characters correspond to characters for right-hand typing on a QWERTY keyboard layout.

F. The method as in paragraph A, wherein the first set of characters and the second set of characters include separate characters of commonly typed bigrams of a predetermined language.

G. The method as in paragraph A, further comprising: selecting an initial character of the first set of characters based on an initial direction of the first directional input; and selecting the first character of the first set of characters further based on a change of the first directional input from the initial direction to a direction that corresponds to the first character without detecting an cessation of the first directional input between the initial direction and the direction that corresponds to the first character.

H. A computing system comprising: one or more processors; memory; and one or more program modules that are stored on the memory and that are executable by the one or more processors to: cause display of a user interface, the user interface including a first set of characters and a second set of characters; associate a first directional control of a user input device with the first set of characters; associate a second directional control of the user input device with the second set of characters; input into a text entry portion of the memory one of the first set of characters based at least on cessation of the first directional input associated with the first directional control; and input into the text entry portion of the memory one of the second set of characters based at least on cessation of a second directional input associated with the second directional control.

I. The computing system as in paragraph H, wherein the one or more modules are further executable to cause display of the one of the first set of characters and the one of the second set of characters within the user interface.

J. The computing system as in paragraph H, wherein the one or more modules are further executable by the one or more processors to determine a character for display based on both the one of the first set of characters and the one of the second set of characters being input into the text entry portion of memory.

K. The computing system as in paragraph J, wherein the one or more modules are further configured to determine the character for display based on the one of the first set of characters and the one of the second set of characters being input into the text entry portion of memory within a predetermined amount of time of one another.

L. The computing system as in paragraph H, wherein the one or more modules are further configured to cause display the one of the first set of characters and the one of the second set of characters within the user interface.

M. The computing system as in paragraph H, wherein the user input device is a game controller, the first directional control includes a first thumbstick, and the second directional control includes a second thumbstick.

N. The computing system as in paragraph M, wherein the first set of characters are arranged around a point such that more frequently selected ones of the first set of characters are situated in first radial directions relative to the point, and less frequently selected ones of the first set of characters are situated in second radial directions relative to the point, wherein manipulation of the first thumbstick associated with the first radial directions includes a thumb pulling motion and manipulation of the first thumbstick associated with the second radial directions includes a thumb pushing motion.

O. The computing device as in paragraph H, wherein the first set of characters correspond to characters for left-hand typing on a QWERTY keyboard layout, and the second set of characters correspond to characters for right-hand typing on a QWERTY keyboard layout.

P. One or more computer-readable media storing instructions executable by one or more processors of a computing system to cause the computing system to: cause display of a user interface, the user interface including a first set of characters arranged in a first area and a second set of characters arranged in a second area; associate first user directional input received via a first directional control of a user input device with the first set of characters; associate second user directional input received via a second directional control of the user input device with the second set of characters; input selected ones of the first set of characters based at least on determining that the first directional input ceases; and input selected ones of the second set of characters based at least on determining that the second directional input ceases.

Q. The one or more computer-readable media as in paragraph P, wherein the instructions are further executable by the one or more processors to cause the computing system to display the selected ones of the first set of characters and selected ones of the second set of characters within the user interface.

R. The one or more computer-readable media as in paragraph P, wherein: the user input device is a game controller, the first directional control includes a first thumbstick, and the second directional control is includes a second thumbstick, an arrangement of the first set of characters in the first area is such that more frequently selected ones of the first set of characters are situated in first radial directions relative to a central point of the first area, and less frequently selected ones of the first set of characters are situated in second radial directions relative to the central point of the first area, and the first radial directions and the second radial directions are such that manipulation of the first thumbstick associated with the first radial directions corresponding to the more frequently selected ones of the first set of characters includes a thumb pulling motion, and manipulation of the first thumbstick associated with the second radial directions corresponding to the less frequently selected ones of the first set of characters includes a thumb pushing motion.

S. The one or more computer-readable media as in paragraph P, wherein the first set of characters and the second set of characters include separate characters of commonly typed bigrams of a predetermined language.

T. The one or more computer-readable media as in paragraph P, wherein the first set of characters correspond to characters identified for left-hand typing on a QWERTY keyboard layout, and the second set of characters correspond to characters identified for right-hand typing on a QWERTY keyboard layout.

### CONCLUSION

Although the disclosure uses language that is specific to structural features and/or methodological acts, the invention is not limited to the specific features or acts described. Rather, the specific features and acts are disclosed as illustrative forms of implementing the invention.

What is claimed is:

1. A method comprising:
causing display of a user interface including a first set of characters and a second set of characters;
associating a first directional control of a user input device with the first set of characters;
associating a second directional control of the user input device with the second set of characters;
selecting at least one of:
a first character of the first set of characters based on receipt of first directional input from the first directional control, and
a second character of the second set of characters based on receipt of second directional input from the second directional control; and
based on detecting that one of the first directional input or the second directional input ceases, inputting the first character or the second character, respectively, into a text entry portion of memory.

2. The method of claim 1, wherein:
the first set of characters are located along first radial vectors that extend outward from a first point, and the second set of characters are located along second radial vectors that extend outward from a second point, such that no more than one of the first set of characters and no more than one of the second set of characters are located along any one of the first radial vectors and second radial vectors, respectively, and
the first character is located in a first radial direction, relative to the first point, that corresponds to the first directional input, and the second character is located in a second radial direction, relative to the second point, that corresponds to the second directional input.

3. The method of claim 1, further comprising causing at least one of the first character or the second character to be displayed in a text entry field within the user interface.

4. The method of claim 1, further comprising based on inputting both the first character and the second character, determining a third character for text entry.

5. The method of claim 4, wherein the first set of characters correspond to characters for left-hand typing on a QWERTY keyboard layout, and the second set of characters correspond to characters for right-hand typing on a QWERTY keyboard layout.

6. The method of claim 1, wherein the first set of characters and the second set of characters include separate characters of commonly typed bigrams of a predetermined language.

7. The method of claim 1, further comprising:
selecting an initial character of the first set of characters based on an initial direction of the first directional input; and
selecting the first character of the first set of characters further based on a change of the first directional input from the initial direction to a direction that corresponds to the first character without detecting an cessation of the first directional input between the initial direction and the direction that corresponds to the first character.

8. A computing system comprising:
one or more processors;
memory; and
one or more program modules that are stored on the memory and that are executable by the one or more processors to:
cause display of a user interface, the user interface including a first set of characters and a second set of characters;
associate a first directional control of a user input device with the first set of characters;
associate a second directional control of the user input device with the second set of characters;
input into a text entry portion of the memory one of the first set of characters based at least on cessation of the first directional input associated with the first directional control; and
input into the text entry portion of the memory one of the second set of characters based at least on cessation of a second directional input associated with the second directional control.

9. The computing system of claim 8, wherein the one or more modules are further executable to cause display of the one of the first set of characters and the one of the second set of characters within the user interface.

10. The computing system of claim 8, wherein the one or more modules are further executable by the one or more processors to determine a character for display based on both the one of the first set of characters and the one of the second set of characters being input into the text entry portion of memory.

11. The computing system of claim 10, wherein the one or more modules are further configured to determine the character for display based on the one of the first set of characters and the one of the second set of characters being input into the text entry portion of memory within a predetermined amount of time of one another.

12. The computing system of claim 8, wherein the one or more modules are further configured to cause display the one of the first set of characters and the one of the second set of characters within the user interface.

13. The computing system of claim 8, wherein the user input device is a game controller, the first directional control includes a first thumbstick, and the second directional control includes a second thumbstick.

14. The computing system of claim 13, wherein the first set of characters are arranged around a point such that more frequently selected ones of the first set of characters are situated in first radial directions relative to the point, and less frequently selected ones of the first set of characters are situated in second radial directions relative to the point, wherein manipulation of the first thumbstick associated with the first radial directions includes a thumb pulling motion and manipulation of the first thumbstick associated with the second radial directions includes a thumb pushing motion.

15. The computing device of claim 8, wherein the first set of characters correspond to characters for left-hand typing on a QWERTY keyboard layout, and the second set of characters correspond to characters for right-hand typing on a QWERTY keyboard layout.

16. One or more computer-readable media storing instructions executable by one or more processors of a computing system to cause the computing system to:
cause display of a user interface, the user interface including a first set of characters arranged in a first area and a second set of characters arranged in a second area;
associate first user directional input received via a first directional control of a user input device with the first set of characters;
associate second user directional input received via a second directional control of the user input device with the second set of characters;
input selected ones of the first set of characters based at least on determining that the first directional input ceases; and
input selected ones of the second set of characters based at least on determining that the second directional input ceases.

17. The one or more computer-readable media of claim 16, wherein the instructions are further executable by the one or more processors to cause the computing system to display the selected ones of the first set of characters and selected ones of the second set of characters within the user interface.

18. The one or more computer-readable media of claim 16, wherein:
the user input device is a game controller, the first directional control includes a first thumbstick, and the second directional control is includes a second thumbstick,
an arrangement of the first set of characters in the first area is such that more frequently selected ones of the first set of characters are situated in first radial directions relative to a central point of the first area, and less frequently selected ones of the first set of characters are situated in second radial directions relative to the central point of the first area, and
the first radial directions and the second radial directions are such that manipulation of the first thumbstick associated with the first radial directions corresponding to the more frequently selected ones of the first set of characters includes a thumb pulling motion, and manipulation of the first thumbstick associated with the second radial directions corresponding to the less frequently selected ones of the first set of characters includes a thumb pushing motion.

19. The one or more computer-readable media of claim 16, wherein the first set of characters and the second set of characters include separate characters of commonly typed bigrams of a predetermined language.

20. The one or more computer-readable media of claim 16 wherein the first set of characters correspond to characters identified for left-hand typing on a QWERTY keyboard layout, and the second set of characters correspond to characters identified for right-hand typing on a QWERTY keyboard layout.
